(19) United States
(12) Patent Application Publication
(10) Pub. No.: US 2011/0262253 A1
(43) Pub. Date: Oct. 27, 2011

(54) STAND-ALONE SHUTTLE CONVEYOR FOR A STORAGE AND/OR LOGISTICS PREPARATION WAREHOUSE

(75) Inventors: Renato Krizmanic, Chevigny-Saint-Sauveur (FR); Joel Foulon, Combertault (FR); Stephane Pietrowicz, Fixin (FR); Jean-David Attal, Dijon (FR); Bernard Piette, Dijon (FR)

(73) Assignee: SAVOYE, Dijon (FR)

(21) Appl. No.: 12/599,938

(22) PCT Filed: May 9, 2008
(86) PCT No.: PCT/FR08/00653

§ 371 Date: Nov. 12, 2009

(30) Foreign Application Priority Data
May 11, 2007 (FR) 0703400

(51) Int. Cl. B65G 1/06

(52) U.S. Cl. 414/279

(57) ABSTRACT

The invention relates to a stand-alone shuttle conveyor (10) intended, in particular, for a storage and logistics preparation warehouse, including a chassis (24) having the following elements mounted thereto, namely: wheels (26) enabling the shuttle conveyor (10) to move; a means (30) for driving the wheels (26); a means for powering the shuttle conveyor, comprising an exclusively electrostatic electrical energy storage means (32); and a means (48) for joining the recharge zones (18, 20) which are connected to a common fixed-voltage electrical power supply (22) in order to recharge the electrical power supply means. The invention is characterised in that the electrical power supply means include a first part for charging the electrical energy storage means (32) and a second part for delivering the energy to the drive means (30), said electrical energy storage means (32) being formed by at least one capacitor. The invention also relates to a storage warehouse (1) including one such shuttle conveyor.

### CROSS-REFERENCE

The present application is a national stage entry of International Application Number PCT/FR2008/000653, filed May 9, 2008 which claims priority to French Patent Application No. 0703400, filed May 11, 2007, the entirety of both of which is incorporated herein by reference.

### FIELD OF THE INVENTION

The invention relates to stand-alone shuttle conveyor, intended, in particular, for a storage and logistics preparation warehouse, for example for preparing orders with single items, comprising at least one automated compact magazine, as well as one automated compact magazine containing such shuttle conveyor.

### BACKGROUND OF THE INVENTION

An automated magazine has a plurality of levels of superposed storage levels inside which stand-alone shuttle conveyors move products around, to place them into their storage locations and to take them from these locations, wherein these shuttle conveyors may not only move horizontally within a given level but may also be moved to other levels by means of elevators.

The storage magazine comprises storage assemblies, wherein each storage assembly is formed by two storage cabinets positioned on either side of a lane, wherein this lane has, at each storage level, tracks for the horizontal movement of a shuttle conveyor and an elevator which is located at one end of the lane. A track is generally formed by two parallel rails and the shuttle conveyor is fitted with wheels to move along these rails.

Within the scope of the present invention, a storage and logistics preparation warehouse inside which the shuttle conveyor operates includes at least one storage magazine as described above. The warehouse may also include tracks connecting one magazine to another, or connecting different operations zones of the storage warehouse to another magazine or to one another, wherein the shuttle conveyor could move on these tracks.

One known solution to ensure the autonomy of movement of the shuttle conveyors consist of using conductor rails connected to an electrical power supply, wherein the electrical equipment of a shuttle conveyor is electrically connected to the rail. However, this solution is not satisfactory, as the rails are very long, which does not allow electrical power to be supplied uniformly to the shuttle conveyor depending in its position in the lane and that, furthermore, due to their length, the cost of the conductor rails represents a major element in the cost of an installation. Moreover, in the event of a bad contact between the rail and he shuttle conveyor, for example if a non-conductive foreign body has fallen onto the rail (e.g. a piece of paper or plastic that has fallen from a storage location), the shuttle conveyor will be immobilised. In this case the entire installation has to be stopped to resolve this manually by moving the shuttle conveyor and removing the foreign body.

Consequently, the utility model DE 101 42 395 describes one variant of this solution, wherein vehicles have contactors which connect them electrically to the rails to supply the electrical power required to drive them. Furthermore, these vehicles have high performance capacitances which supply the surplus energy required during the acceleration phases and which may be recharged via the rails especially when moving which do not require said energy surplus. In this case, the capacitances only provide top-up energy.

Another known solution consists of equipping a shuttle conveyor with a battery of rechargeable batteries. The disadvantage of this solution is that recharging the batteries is a complicated operation, as the charging voltage needs to be monitored, as well as the temperature, the current, etc. This generally means that the shuttle conveyor has to be removed from the storage magazine to be charged on a charging station where an operator can monitor the charging parameters, or to fit the shuttle conveyor with a complex electronic system to monitor the charging of the batteries. Furthermore, the capacity of the battery is downgraded after every recharge, such that a battery is no longer fit for use after a series of approximately 500 charge cycles. Moreover, the charge current is limited, which leads to over-sizing the batteries so as to recharge during the operating cycle of the shuttle conveyor, which induces extra costs.

For example, the utility model DE 20 2007 003 447, proposes to power the electric drive motors of the shuttle conveyor by rechargeable energy storage which may be indifferently a battery of batteries, a rechargeable battery, a capacitor or any other similar device. However, no actual technical application comprising a capacitor or a battery of capacitors as the main source of energy is proposed in this document.

### SUMMARY OF THE INVENTION

The purpose of the invention is to provide a stand-alone shuttle conveyor which overcomes the disadvantages of the shuttle conveyors of the prior art.

To this end, the subject of the invention is a stand-alone shuttle conveyor, intended, in particular, for a storage and logistics preparation warehouse, for example for preparing orders with single items, comprising at least one automated compact magazine, including a chassis having the following elements mounted thereto, namely:
wheels enabling the shuttle conveyor to move along the rails of the warehouse or storage magazine,
a drive means for the wheels,
an electrical power supply means for the shuttle conveyor, comprising an electrical energy storage means, of exclusively electrostatic type and,
a joining means with the recharge zones which are connected to a common fixed-voltage electrical power supply in order to recharge the electrical power supply means,
   wherein this shuttle conveyor is remarkable in that the electrical power supply means include a first part for charging the electrical energy storage means and a second part for delivering the energy to the drive means, wherein said electrical energy storage means is formed by at least one capacitor, wherein the first part comprises a common isolating current limiter positioned between the common fixed-voltage electrical power supply and the electrical energy storage means, and which permits the intensity of the current to be adapted to suit the voltage of the electrical energy storage means which depends on the charge level of said electrical energy storage means wherein the second part comprises a DC/DC converter positioned between the electrical energy storage means and the drive means and which allows a constant voltage to be supplied to the terminals of the drive means.

Preferably, the electrical energy storage means comprises a battery of super-capacitors.

Another purpose of the invention is an compact automated storage magazine comprising a storage cabinet with several levels of superposed storage, wherein an lane comprises for each level a track, at least one stand-alone shuttle conveyor which may move along a track to add or remove items from the storage cabinet, and an elevator to move a stand-alone shuttle conveyor from one storage level to another, wherein said magazine is characterised in that it comprises a plurality of recharge zones which may each accommodate a shuttle conveyor, wherein said recharge zones of the lane are connected to a common energy source and each shuttle conveyor is a shuttle conveyor according to the invention.

Preferably, each track comprises a recharge zone and, advantageously the recharge zone of a track is located at one end of said track and in that the elevator is located close to said end of track.

According to one advantageous embodiment, the elevator comprises a recharge zone.

Preferably, the storage magazine comprises for each lane two storage cabinets located on either side of this lane and advantageously comprises a plurality of them.

### DESCRIPTION OF THE DRAWINGS

The invention will be more clearly understood upon reading the following embodiments, provided by way of illustration but in no way restrictively, in reference to the appended drawings, in which:

FIGS. 1 and 2 respectively show diagrammatically a top view and a cross sectional view according to the II-II axis of FIG. 1 of a storage magazine according to the invention,

FIG. 3 shows a top view of a stand-alone shuttle conveyor according to the invention,

FIG. 4 shows a side view of the stand-alone shuttle conveyor of FIG. 3, according to direction A,

FIG. 5 shows diagrammatically an embodiment of the electrical power supply means on board the shuttle conveyor, and

FIG. 6 shows diagrammatically an embodiment of the current limiter.

### DETAILED DESCRIPTION OF PREFERRED EMBODIMENTS

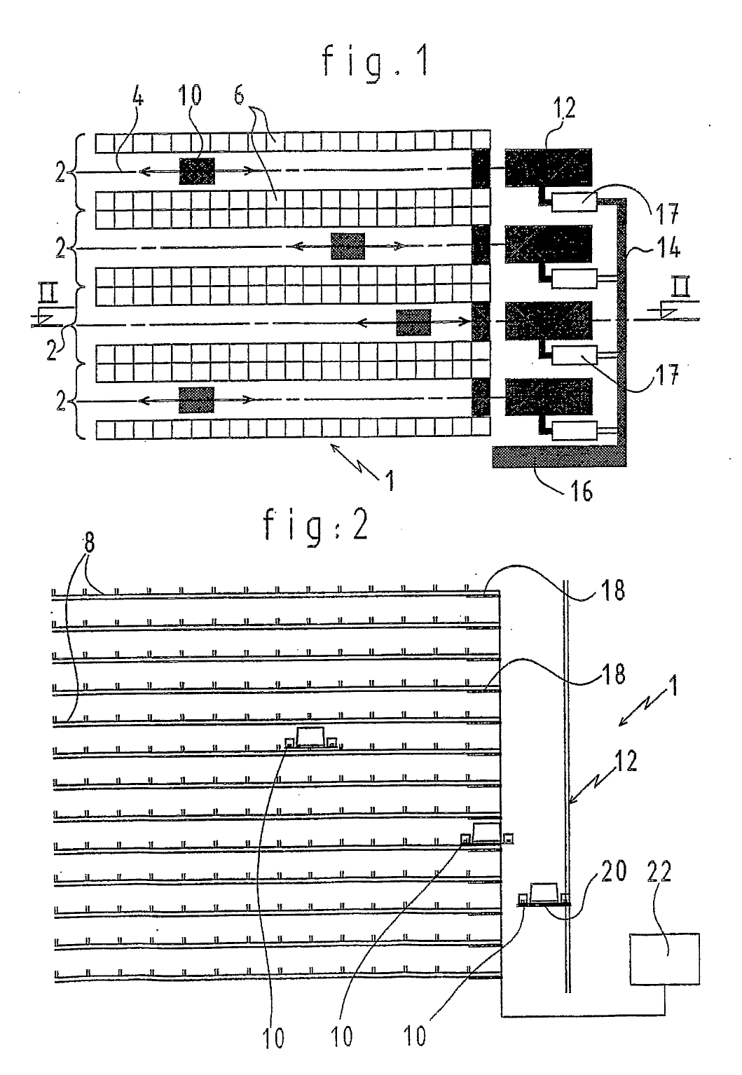

The storage magazine 1 shown in FIGS. 1 and 2 comprises four storage assemblies 2, each comprising one lane 4, two storage cabinets 6 at each level and, on each level, a track 8 comprising two parallel rails for the movement of a shuttle conveyor 10. Each storage assembly 2 is associated to an elevator 12, located at one end of the lane 4, to transport a shuttle conveyor 10 from one level to another level.

A conveyor 14 is positioned so that it may receive objects from a shuttle conveyor 10 located inside an elevator 12 and transport them to a collection station 16. A buffer zone 17 is interposed between the elevator 12 and the conveyor 14, to make it easier for the objects to circulate on the conveyor 14 supplied from the various elevators 12.

This same conveyor may also be used to bring objects that are to be put into stock to a shuttle conveyor 10 located inside an elevator 12. Alternatively, the objects may be stored by means of a second set of elevators located at the other end of the lanes.

It may be noted that the number of shuttles per lane may be chosen freely between 1 and n, where n is the number of levels in the storage cabinets in the lane, according to the function envisaged, and especially parameters such as the speed of stock rotation, the maximum desired time to access an object, the cost of the installation, etc.

It may be understood that in general, a storage magazine 1 may only comprise a single lane and that each lane is associated to one or two storage cabinets.

According to the invention, the magazine comprises recharge zones to recharge the shuttle conveyors 10.

Preferably, as shown in FIG. 2, each track 8 includes at least one section of track 18 that is electrically conductive that defines a recharge zone. This section of track comprises two conductor rails, which may form the rails of the track 8 itself or which may be additional rails parallel to those of the track 8.

For access reasons, and especially for maintenance, it is advantageous to locate the sections of track 18 at one end of the lane. And even more advantageously, the sections of track 18 are located at the end of the lane next to the elevators 12.

The elevator may also be equipped with a section of track 20 defining a recharge zone.

The recharge zones thus correspond to wait zones, either the shuttle conveyor 10 is on a section 18 waiting for a new mission or the elevator 12, or it is on the section of track 20 being moved vertically by the elevator 12. Of course, additional recharge zones may be provided, located in other positions on the tracks.

According to the invention, all of the sections of track 20 are connected to a common electrical power supply 22 per lane.

In the case of a plurality of lanes, a single electrical power supply may be envisaged for all of the lanes or for a sub-group of lanes.

Moreover, in a warehouse configuration where the shuttle conveyor has to travel on tracks outside of the magazine, in order to connect several stores or several different operations zones of the warehouse to one another, it may be understood that these tracks will also comprise recharge zones, located at regular intervals along the tracks according to the autonomy of the shuttle conveyors as well as at strategic wait positions (zones for loading/unloading, vertical transfers, etc.).

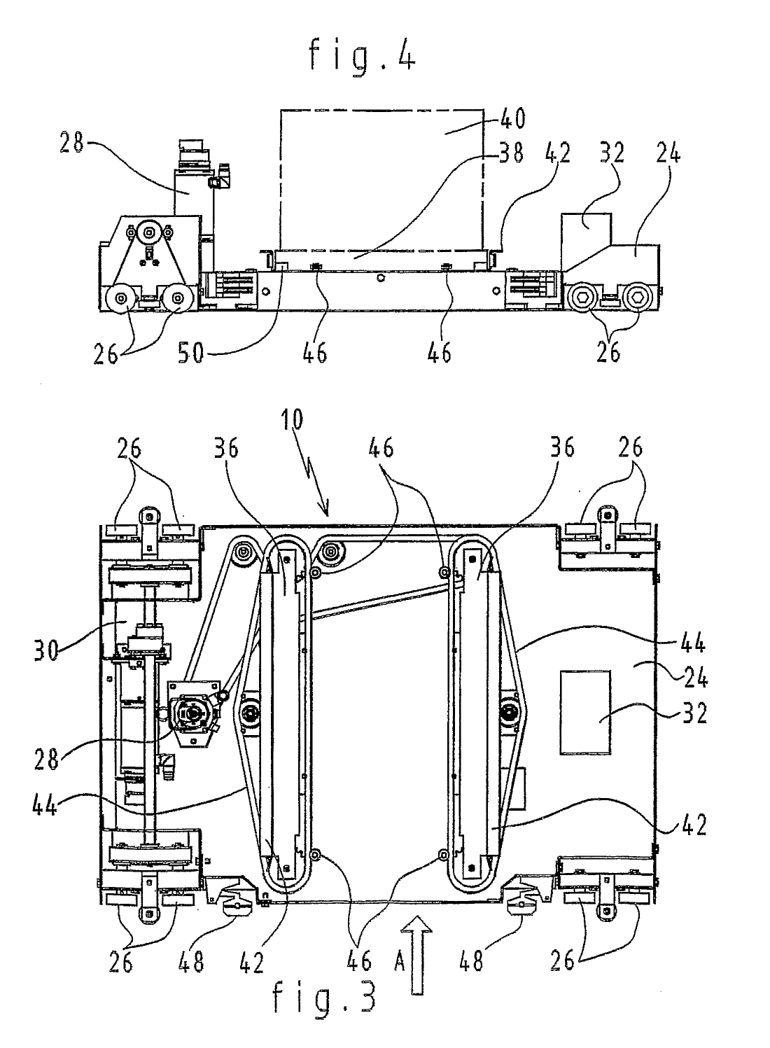

One embodiment of a shuttle conveyor 10 according to the invention is shown in FIGS. 3 and 4.

The shuttle conveyor 10 comprises a chassis 24 onto which wheels 26 are mounted to permit the shuttle conveyor 10 to move along a track 8 of the storage magazine 1.

It also comprises drive means comprising an electric motor 30 coupled to the wheels 26. This motor is powered by a battery of super-capacitors 32 on-board the shuttle conveyor 10.

In its central section, the shuttle conveyor 10 comprises a housing zone 36 to accommodate a plate 38 that can hold an object 40 such as for example a box or a container, guide rails 42 and transfer means to move the plate 38 from a location in the storage magazine 1 to the shuttle conveyor 10 or vice versa, according to a direction perpendicular to that of the track 8.

In the embodiment shown, the transfer means comprise two loops 44 that may be driven in rotation by the motor 28. Each loop 44 has two gripping rods 46 which engage with the plate 38 to drive it in a translation movement according to a direction that is perpendicular to that of the track 8. The motor 28 is advantageously powered by the same battery of super-capacitors 32 as that of the motor 30. For further details concerning the operation of the transfer means, reference may be made to a patent application registered concomitantly in the name of the applicant.

The shuttle conveyor 10 further comprises current collectors 48 to recharge the battery of super-capacitors 32 when the shuttle conveyor 10 is in a recharge zone.

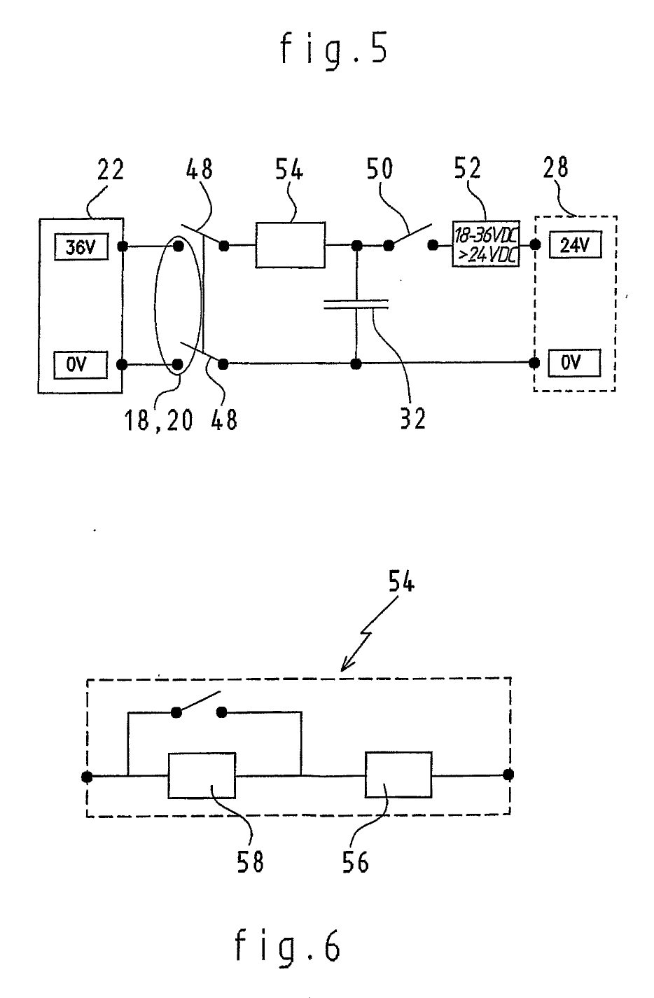

FIG. 5 illustrates diagrammatically the corresponding electrical circuit.

The section of track 18 comprises two rail elements connected to two voltage terminals of the electrical power supply 22. When the shuttle conveyor 10 is in the recharge zone, each current collector is in contact with one of the rail elements of the section of track 18.

The terminals of the battery of super capacitors 32 are each connected to a current collector 48, possibly via a current limiter, and to a voltage converter which supplies a stabilised voltage to the electrical equipment of the shuttle conveyor (motors 28, 30, and other automated devices). Indeed, the voltage from the battery of super capacitors 32 drops significantly during discharge between a maximum value and a minimum value (for example from 36 to 18 V), which is why a voltage converter is used. For example, as shown in FIG. 5, the electrical power supply 22 is a voltage of 36V and the motor operates with a voltage of 24V. AC/DC converter which supplies a constant voltage of 24V to the motor 28 is therefore placed in between the battery of super capacitors 32 and the motor 28.

The battery of super capacitors 32 is recharged in the recharge zones and powers the motor 28 when a control switch is in the closed position.

According to the invention, there is a single electrical power supply for at least the recharge zones of a storage assembly (one lane and one elevator) and may include several shuttle conveyors. It is therefore possible that several shuttle conveyors are waiting simultaneously in different recharge zones. The voltage from the battery of super capacitors varies strongly during the charge (for example between 18 and 36 V).

In order for the shuttle conveyors to be recharged correctly, regardless of the number of shuttle conveyors, and to protect the battery of super capacitors 32, a current limiting device 54 is positioned between the common electrical power supply 2 and the battery of super capacitors 32.

This current limiter 54 may be either incorporated into the common power supply 22 or be an electronic routing device. It may also be made very simply, as shown in FIG. 6, by a set of two resistors 56 and 58, wherein the resistor 56 limits the current, for example to 20 A, during the normal operating cycle (voltage of the battery of super capacitors 32 varying for example between 18 and 36 V). The resistor 58 is active at the start of the charge, when the battery of super capacitors 32 is completely discharged. It is then bypassed when the voltage of the battery of super capacitors 32 reaches the minimum value of the operating cycle (for example 18 V). This current limiter 54 thus permits the intensity of the current to be adapted to suit the voltage of the energy storage means 32 which depends on the level of charge of said electrical energy storage means 32.

Moreover, the shuttle conveyor 10 comprises a device for controlling the level of charge of the electrical energy storage means and in particular the battery 32 of super capacitors, which will condition the stoppage and the duration of the stop of the shuttle conveyor in a recharge zone, whether this is in the magazine 1 or outside of it.

Finally, it is obvious that the present invention is not restricted to the embodiments described, but that it may be modified or adapted to suit specific requirements or constraints, without this being outside of the scope of the invention.

1. A stand-alone shuttle conveyor, intended, in particular, for a storage and logistics preparation warehouse, comprising at least one compact automated storage magazine, including a chassis having the following elements mounted thereto, namely:
wheels enabling the shuttle conveyor to move along the rails of a track of the warehouse or storage magazine,
a drive means for the wheels,
an electrical power supply means for the shuttle conveyor, comprising an electrical energy storage means, of exclusively electrostatic type and,
a joining means with the recharge zones which are connected to a common fixed-voltage electrical power supply in order to recharge the electrical power supply means, wherein the electrical power supply means includes a first part for charging the electrical energy storage means and a second part for delivering the energy to the drive means, wherein said electrical energy storage means is formed by at least one capacitor, wherein the first part comprises a common isolating current limiter positioned between the common fixed-voltage electrical power supply and the electrical energy storage means, and which permits the intensity of the current to be adapted to suit the voltage of the electrical energy storage means which depends on the charge level of said electrical energy storage means, wherein the second part comprises a DC/DC converter positioned between the electrical energy storage means and the drive means and which allows a constant voltage to be supplied to the terminals of the drive means.

2. A shuttle conveyor according to claim 1, wherein the electrical energy storage means comprises a battery of super capacitors.

3. A shuttle conveyor according to claim 1, wherein the current limiter is a resistive device comprising at least one resistor.

4. A shuttle conveyor according to claim 3, wherein the current limiter comprises two resistors fitted in series, one of which may be bypassed.

5. A shuttle conveyor according to claim 1, wherein the current limiter is an electronic routing circuit.

6. A shuttle conveyor according to claim 1, further comprising a device for controlling the level of charge of the electrical energy storage means.

7. A compact automated storage magazine comprising a storage cabinet with several levels of superposed storage, wherein a lane comprises for each level a track, at least one stand-alone shuttle conveyor which may move along a track to add or remove items from the storage cabinet, and an elevator to move a stand-alone shuttle conveyor from one storage level to another, wherein said magazine is characterised in that it comprises a plurality of recharge zones which may each accommodate a shuttle conveyor, wherein said recharge zones of the lane are connected to a common energy source and each shuttle conveyor is a shuttle conveyor according to claim 1.

8. A storage magazine according to claim 7, wherein each track comprises at least one recharge zone.

9. A storage magazine according to claim 7, wherein the recharge zone of a track is located at one end of said track and the elevator is located close to said end of the track.

10. A storage magazine according to claim 7, wherein the elevator comprises a recharge zone.
